(19) United States
(12) Patent Application Publication
(10) Pub. No.: US 2006/0278857 A1
(43) Pub. Date: Dec. 14, 2006

(54) Self locking hydraulic jack

(76) Inventor: Virgil Brocchini, Madera, CA (US)

Correspondence Address: US CORPORATIONS, INC., P.O. BOX 234265, ENCINITAS, CA, 92023, US

(21) Appl. No.: 11/151,767

(22) Filed: Jun. 14, 2005

(51) Int. Cl. B60P 1/48

(52) U.S. Cl. 254/8 B

(57) ABSTRACT

Disclosed is a self locking hydraulic jack for lifting an automobile provided with an arm lock mechanism and foot pedal so that the lifting arm is prevented from inadvertently falling from mechanical failure or due to loss of hydraulic pressure. The safety to the user of the garage jack is enhanced. Additionally, self locking hydraulic jack is provided with a foot pedal for ease of activation or de-activation.

### CROSS-REFERENCE TO RELATED APPLICATION

Ser. No. 60/581,339

### STATEMENT REGARDING FEDERALLY SPONSORED RESEARCH OR DEVELOPMENT

Not applicable

### REFERENCE TO SEQUENCE LISTING

Not applicable

### FIELD OF THE INVENTION

This invention relates to a lifting jack for an automobile and in particular to a so-called garage jack or a service jack for an automobile which is provided with a lock mechanism for preventing its lifting head from falling even in case of the leakage of hydraulic fluid or jack failure.

### BACKGROUND OF THE INVENTION

Most automobile floor jacks have a lifting head which may be lifted up or lowered down by a hydraulic power unit incorporated in the frame of the jack main body by way of a lifting arm which is pivoted to the frame at its proximal end. In common use and from the view point of safety, jack stands are used in case of mechanical failure allowing the jack lifting head to fall. An arm lock mechanism is also sometimes provided in association with the lifting arm of the garage jack to prevent it from inadvertently falling due to the leakage of hydraulic fluid from the hydraulic cylinder of the power unit.

In general, conventional arm lock mechanisms have the shortcomings that their structures are not durable enough to assure the safety required in the industry or the ease of use necessary. And the failure of such an arm lock mechanism could lead to accidents and even death to the user.

In review of such shortcomings of the arm lock mechanisms of previous garage jacks, a primary object of this invention is to provide a garage jack for an automobile with an reliable arm lock mechanism which is highly durable and easy to engage and release so that the garage jack may be utilized for servicing an automobile substantially without any danger of failure to support the automobile or the inconvenience of attachments.

Accordingly, it is among the objects of the present invention to provide a novel self locking hydraulic jack which is simple to manufacturer, and economical in cost. Another objective of the present invention is to provide a self locking hydraulic jack which may be safe and reliable in the common work place. Still another objective is to provide a self locking hydraulic jack which is highly effective when used as specified and according general practice in the automotive work place.

One object of the present invention is to provide a self locking hydraulic jack, which provides substantial effectiveness without adverse and unnecessary safety risks.

It is an objective of the invention to provide a self locking hydraulic jack which is relatively cost effective and convenient to store.

It is a further object of the invention to provide a self locking hydraulic jack which is designed to be ergonomically designed for ease to engage and release the locking device.

It is yet a further object of the invention to provide self locking hydraulic jack which is inexpensive and easy to manufacture.

In accordance with the above objectives, a self locking hydraulic jack provided which comprises the combination of a foot pedal, engagement arm and locking brace.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the previous following description. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the construction of other modifications, methods and elements for carrying out the several purposes of the present invention. It is important, therefore, that the claims be regarded as including such equivalent constructions insofar as they do not depart from the spirit and. scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a self locking hydraulic jack which has many of the advantages of the closures mentioned heretofore and many novel features that result in self locking hydraulic jack which is not anticipated, rendered obvious, suggested, or even implied by any of the prior art tool guides, either alone or in any combination thereof.

An even further object of the present invention is to provide a and self locking hydraulic jack which is susceptible of a low cost of manufacture with regard the combination of all materials and labor, and which accordingly is then susceptible of low prices of sale to the consuming public, thereby making such a device economically available to the buying public.

Still yet another object of the present invention is to provide a self locking hydraulic jack which provides methods of the prior art some of the advantages thereof, while simultaneously overcoming some of the disadvantages normally associated therewith.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the descriptive matter in which there are illustrated preferred embodiments of the invention.

I have shown but a few embodiments of the invention, it will be apparent to those skilled in the art that the invention may be embodied still otherwise without departing from the spirit and scope of the invention.

### DESCRIPTION OF THE DRAWINGS

In order that the present invention may be better understood, a preferred embodiment thereof will now be described with reference to the accompanying drawings, in which:

FIG. 1 is a side view of a hydraulic lifting jack including a safety device for an elevator therein made in accordance with the present invention;

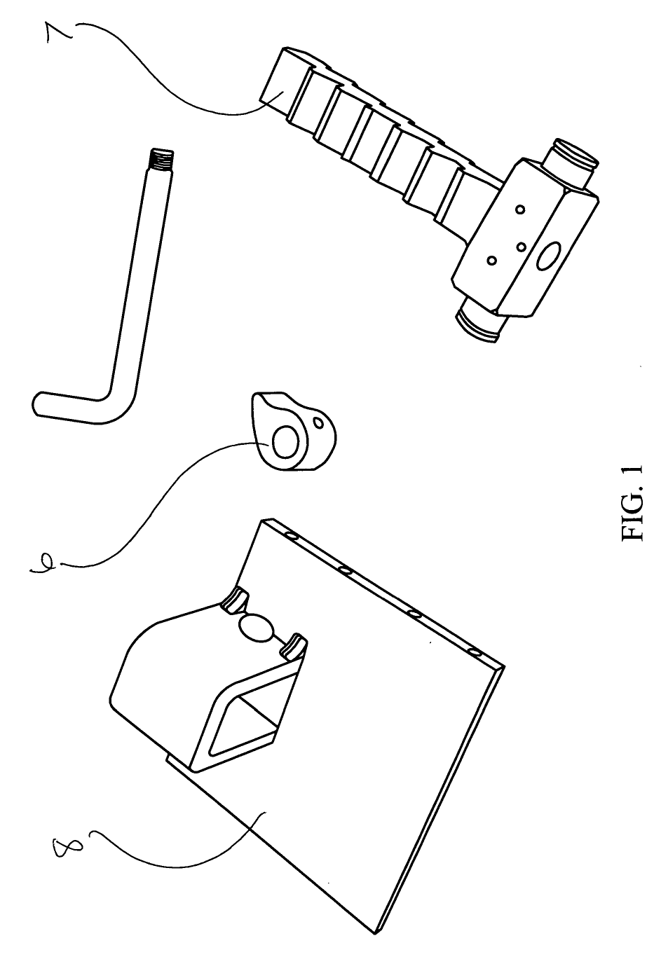

FIG. 2 is a fragmentary view showing the safety device of the lifting jack in FIG. 1, when the elevator is lifted.

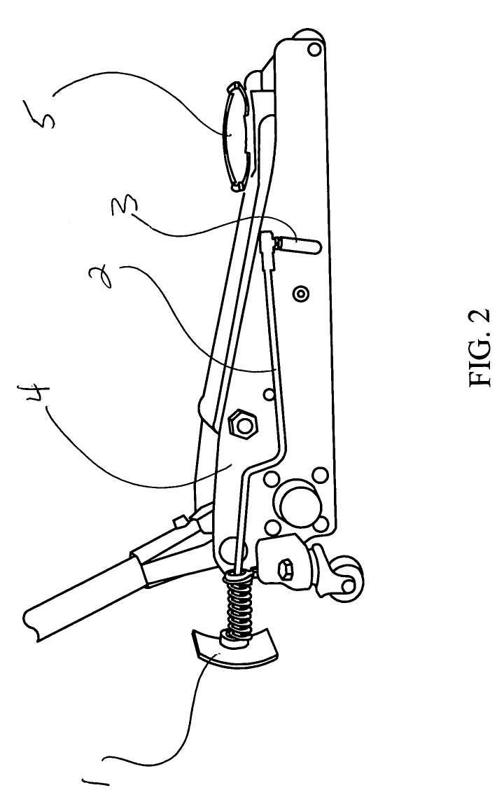

Having thus described the invention, what is desired to be secured by a patent is:

### ILLUSTRATION ATTACHMENT SHEET 1

The spring on the foot pedal (1) is connected by a ¼″ rod (2) to the lock pin ((3) and holds constant pressure on the hook (6) as you raise the jack (4) and attached lift pad (5) using its hydraulics the hook is forced into each notch on the lock shaft (7) Then by releasing the jack hydraulics the lock remains engaged acting as a Jack stand not allowing the jack to lower. And can only be released by using the jack raising procedure (jacking movement) then hold the foot pedal release and release the jack hydraulics (by turning handle) and jack will return to lowered position.

I claim:

1. A self locking hydraulic floor jack for lifting provided with an arm lock and foot pedal mechanism for preventing inadvertent fall of a lifting arm, comprising:
a foot pedal which is provided with a control rod connected to the lock pin which holds constant pressure on the hook as you raise the jack using its hydraulics;

2. A self locking hydraulic floor jack and method according to claim 1 wherein;
The locking mechanism is spring loaded.

3. A self locking hydraulic jack according to claim 1 wherein;
the jack is manufactured of solid steel or aluminum.

4. A self locking hydraulic jack according to claim 1 wherein; the device cannot be unlocked unless the load or weight has been lifted off by using the jack hydraulics while pushing the foot pedal.

5. A self locking hydraulic jack according to claim 1 wherein; the device utilizes a ratchet lock and foot pedal release.

6. A self locking hydraulic jack according to claim 1 wherein; the device locking mechanism engages automatically as the jack platform is raised.
